(19) United States
(12) Patent Application Publication
(10) Pub. No.: US 2007/0028145 A1
(43) Pub. Date: Feb. 1, 2007

(54) RAID-6 MULTIPLE-INPUT, MULTIPLE-OUTPUT FINITE-FIELD SUM-OF-PRODUCTS ACCELERATOR

(75) Inventors: Adrian Cuenin GERHARD, Rochester, MN (US); Daniel Frank MOERTL, Rochester, MN (US)

Correspondence Address: OPPEDAHL & OLSON LLP, P.O. BOX 4850, FRISCO, CO, 80443-4850, US

(73) Assignee: ADAPTEC, INC., Milpitas, CA (US)

(21) Appl. No.: 11/163,347

(22) Filed: Oct. 15, 2005

Related U.S. Application Data
(63) Continuation of application No. PCT/IB05/53252, filed on Oct. 3, 2005.
(60) Provisional application No. 60/595,680, filed on Jul. 27, 2005.

(51) Int. Cl. G06F 11/00

(52) U.S. Cl. 714/36

(57) ABSTRACT

A standalone hardware engine is used on an advanced function storage adaptor to improve the performance of a Reed-Solomon-based RAID-6 implementation. The engine can perform the following operations; generate P and Q parity for a full stripe write, generate updated P and Q parity for a partial stripe write, generate updated P and Q parity for a single write to one drive in a stripe, generate the missing data for one or two drives. The engine requires all the source data to be in the advanced function storage adaptor memory (external DRAM) before it is started, the engine only needs to be invoked once to complete any of the four above listed operations, the engine will read the source data only once and output to memory the full results for any of the listed four operations. In some prior-art systems, for N inputs, there would be 6N+2 memory accesses. With this approach, the same operation would require only N+2 memory accesses.

### CROSS-REFERENCE TO RELATED APPLICATIONS

This application is a continuation of US application number PCT/IB2005/053252, filed Oct. 3, 2005, designating the United States, which application is incorporated herein by reference for all purposes. International application number PCT/IB2005/053252 claims priority from U.S. application No. 60/595,680 filed Jul. 27, 2005, which application is also incorporated herein by reference for all purposes.

### BACKGROUND OF THE INVENTION

There are many flavors or levels of RAID (redundant array of inexpensive disks). RAID 1, for example, provides two drives, each a mirror of the other. If one drive fails, the other drive continues to provide good data. In a two-drive RAID-1 system, loss of one drive gives rise to a very sensitive situation, in that loss of the other drive would be catastrophic. Thus when one drive fails it is extremely important to replace the failed drive as soon as possible.

RAID 0 separates data into two or more “stripes”, spread out over two or more drives. This permits better performance in the nature of faster retrieval of data from the system, but does not provide any redundancy.

RAID 10 provides both mirroring and striping, thereby offering improved performance as well as redundancy.

Other RAID levels have been defined. RAID 5 has been defined, in which there are N+1 drives in total, composed of N data drives (in which data are striped) and a parity drive. Any time that data are written to the data drives, this data is XORed and the result is written to the parity drive. In the event of loss of data from any one of the data drives, it is a simple computational matter to XOR together the data from the other N−1 drives, and to XOR this with the data from the parity drive, and this will provide the missing data from the drive from which data were lost. Similarly if the parity drive is lost, its contents can be readily reconstructed by XORing together the contents of the N data drives. (In exemplary RAID-5 systems the drives are striped with the parity information for a given stripe placed on any of several drives, meaning that strictly speaking no single drive is confined to carrying parity information, but for simplicity of description we refer to one of the drives as a parity drive.) This is one of the most widely employed levels of RAID in recent times, because it offers the performance benefits of striping, and because the calculations (XOR) are extremely simple and so can be easily implemented and are fast calculations. Performance is very good and reconstruction of a failed drive (e.g. to a hot spare) is fast (because it requires no computation more complicated than a simple XOR). For all of its advantages and widespread use, RAID 5 has a potential drawback which is that loss of two drives is catastrophic. Stated differently, if a second drive were to fail (in a RAID-5 system) at a time when the failure of a first drive had not yet been attended to (e.g. by replacement or by shifting to a hot spare) then the RAID system will not be able to recover from the loss of the second drive.

RAID 6 has been defined, in which there are N+2 drives where N of which contain data and the remaining two drives contain what is called P and Q information. The P and Q information is the result of applying certain mathematical functions to the data stored on the N data drives. The functions are selected so as to bring about a very desirable result, namely that even in the event of a loss of any two drives, it will be possible to recover all of the data previously stored on the two failed drives. (With RAID 6, as with RAID 5, in an exemplary embodiment the redundancy P and Q information is placed on various of the drives on a per-stripe basis, so that strictly speaking there is no dedicated P drive or Q drive; for simplicity of explanation this discussion will nonetheless speak of P and Q drives.)

In a Reed-Solomon-based RAID-6 implementation, an array of N+2 drives on a given stripe will have N drives containing data for that stripe and 2 drives containing redundancy data for the stripe (P and Q “parity”). The redundancy data is not actual parity but is used in the same fashion as parity is used in a RAID-5 implementation and thus, in this discussion, the term “parity” will be used in some instances. This redundancy data is calculated based on two independent equations which each contain one or both of the two redundancy data values as terms. Given all of the data values and using algebra, the two equations can be used to solve for the two unknown redundancy data values.

Once each piece of redundancy data can be described in terms of the data that is available, there remains the task of actually performing the necessary multiplications and additions to get a result. In the case of a partial-stripe write, where all of the new data is not available, the firmware must first instruct the hardware to read the current data into memory and then the same process is performed.

For a single write, based on the two equations governing the RAID-6 implementation, two new equations can be derived which solve for the new P and Q values based on the change in the single data drive being update, and the old P and Q values. Once these equations are derived, firmware must instruct the hardware to read the old data (and calculate the difference between the old and new), the old P and the old Q from the drives into memory. Then, using the two new equations, this invention can be used to build the new P and Q.

For a rebuild, again, equations can be derived to describe the missing drive or two missing drives based on the remaining drives. Firmware needs only to instruct the hardware to read in the data from the remaining drives into memory and to use this invention to calculate the data for the missing drives.

To calculate the results in these equations, each source data value will need to be multiplied by some constant and then added to calculate the sum of products for each result data value. The multiply needed is a special finite-field multiply defined by the finite field being used in the RAID-6 implementation. (Finite-field addition is simply XOR.)

Performance and redundancy. With many RAID levels other than RAID 6, then, a chief question is “what are the chances that two drives would turn out to have failed at the same time?” A related question is “what are the chances that after a failure of a first drive, and before that first drive gets replaced, a second drive fails?” The answer to the questions is on the order of p², where p is the probability of failure of one drive during a particular interval.

With RAID 6, however, a chief question is “what are the chances that three drives would turn out to have failed at the same time?” A related question is “what are the chances that after a failure of a first drive, and before that first drive gets replaced, a second drive fails, and before either of the two drives gets replaced, a third drive fails?” The answer to these questions is on the order of p³.

Because p is very small, p³ is much smaller than p². This is part of why RAID 6 poses less of a risk of catastrophic data loss as compared with some other RAID levels.

In real-life applications, however, it is not enough that a particular level of RAID (e.g. RAID 6) offers a desirably low risk of data loss. There is an additional requirement that the system perform well. In disk drive systems, one measurement of performance is how long it takes to write a given amount of data to the disks. Another measurement is how long it takes to read a given amount of data from the disks. Yet another measurement is how long it takes, from the moment that it is desired to retrieve particular data, until the particular data are retrieved. Yet another measurement is how long it takes the system to rebuild a failed drive.

In RAID 6, calculations must be performed before data can be stored to the disks. The calculations take some time, and this can lead to poor performance. Some RAID-6 implementations have been done in software (that is, the entire process including the calculations is done in software) but for a commercial product, the complexity of performing the finite-field multiply in software would cause the performance of such an implementation to be terrible.

In other RAID-6 implementations, a finite-field multiply accelerator is provided. However, even with this, there is a read from memory and a store back to memory for every multiply performed. Then to “sum” the products using an XOR accelerator, there is another N reads for N sources and one write. In such a prior RAID-6 implementation, two multiplies would need to be performed for each source and two results would need to be computed. So, for N inputs, there would be 6N+2 memory accesses.

In a Reed-Solomon-based RAID-6 implementation using finite-field arithmetic, each byte of multiple large sets of data must be multiplied by a constant specific to each set of input data and which set of redundancy data is being computed. Then after each set of input data has been multiplied by the appropriate constant, each product is added together to generate the redundancy data. The finite-field calculation may be thought of as the evaluation of a large polynomial where the inputs are integers within a particular domain and the intermediate results and outputs are also integers, spanning a range that is the same as the domain.

Given this must be done for each set of redundancy data, this whole process can be quite compute intensive. This is worsened by the fact that finite-field multiplication is not done by a standard arithmetic multiply so doing so in a processor is a fairly compute intensive task in itself. Finite field addition is simply an XOR operation so (when compared with finite-field multiply) computationally it is no more difficult than normal addition.

Even with hardware accelerators to perform the finite-field multiply, running the multiplies independently cause two memory accesses for each multiplication performed. To generate parity for a stripe write, with N input buffers and 2 destinations, this would result in 6N+2 memory accesses.

In the past, due to questions as to whether the desired performance could be achieved, RAID-6 was not really used in industry. Reed-Solomon-based RAID-6 has been understood for many years but previously it was thought to not be worth the cost. So, most implementations were limited to academic exercises and thus simply did all of the computations in software. RAID 6, implemented with all calculations in software, performs extremely poorly and this is one of the reasons why RAID 6 has not been used very much. Because of this, much attention has been paid in recent years to try to devise better approaches for implementing RAID 6. Stated differently, there has been a long-felt need to make RAID 6 work with good performance (a need that has existed for many years) and that need has not, until now, been met.

As mentioned above, one approach used in some DMA controllers found in RAID-6 capable subsystems is to provide an accelerator to perform a finite-field multiplication on a set of data. Most RAID subsystems that have a DMA controller also have an accelerator to perform an XOR on two or more sets of data (usually buffered in memory somewhere within the subsystem) and place the result in a destination buffer. Using these two features, the finite-field sum-of-products calculations needed for these various RAID-6 operations can be performed in much less time and with much less work by the processor than if all of the work were done in software.

It turns out, however, that that solution is still not optimal. The multiplier reads data from a source buffer, performs the multiplication, then writes the result out to a destination buffer. This is often done twice for every input buffer because two results are often needed and each source must be multiplied by a two different constants. Also, once the multiplications have been completed, each product buffer must be XORed together. In the best case, to XOR all of the product buffers will require the XOR accelerator to read the data from the source buffers once and write out the result to a destination buffer. Again, this often must be done twice, once for each set of result data generated. While this approach yields better performance than a system accomplished solely in software, it still provides very poor performance as compared with other (non-RAID-6) RAID systems.

It will thus be appreciated that there has been and is a great and long-felt need for a better way to implement RAID 6. It would be extremely helpful if an approach could be devised which would provide RAID 6 function with good performance.

### SUMMARY OF THE INVENTION

As mentioned above, a standalone hardware engine is used on an advanced function storage adaptor to improve the performance of a Reed-Solomon-based RAID-6 implementation. The engine can perform the following operations:
generate P and Q parity for a full stripe write,
generate updated P and Q parity for a partial stripe write,
generate updated P and Q parity for a single write to one drive in a stripe, and
generate the missing data for one or two drives.

The engine requires all the source data to be in the advanced function storage adaptor memory (external DRAM) before it is started. The engine only needs to be invoked once to complete any of the four above listed operations. The engine will read the source data only once and output to memory the full results for any of the listed four operations.

In some prior-art systems, for N inputs, there would be 6N+2 memory accesses. With this approach, on the other hand, the same operation would require only N+2 memory accesses.

### DESCRIPTION OF THE DRAWING

The invention will be described with respect to a drawing in several figures.

FIG. 1 shows a hardware accelerator in functional block diagram form.

FIG. 2 shows a RAID 6 subsystem employing a hardware accelerator such as that shown in FIG. 1.

### DETAILED DESCRIPTION

The invention will now be described in some detail with respect to some of the functions provided.

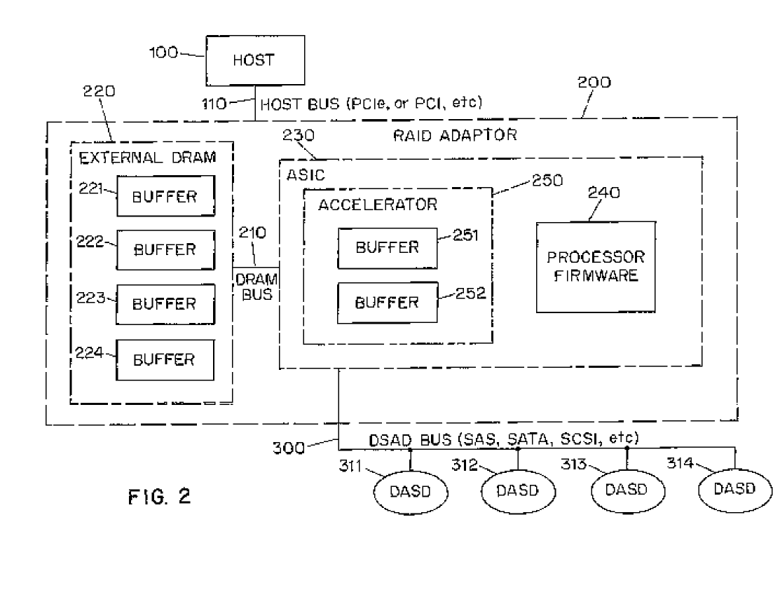

Full-stripe write. For a full-stripe write, firmware (e.g. firmware 240 in FIG. 2) will first instruct the hardware to DMA (for example via host bus 110) all the new data to memory (e.g. DRAM 220 in FIG. 2). Then firmware will invoke this invention only once to generate both the P and Q parity (which are for example found in buffers 251, 252 in FIG. 2 at the end of the invocation of the invention). Per this invention hardware will read data only once from memory (for example via DRAM bus 210 in FIG. 2) and then write to memory both the new P and Q parity (further details of this invention's flow are described below). (DASD means direct access storage device.) Firmware then instructs hardware to write the stripe data to all the data drives and to write the P parity and Q parity to those parity drives, for example via DASD bus 300 in FIG. 2.

Partial-stripe write. For a partial-stripe write, firmware (e.g. firmware 240 in FIG. 2) will first instruct the hardware to DMA (for example via host bus 110) all the new data to memory (e.g. DRAM 220 in FIG. 2). Then firmware will instruct hardware to read into memory the current data for the stripe from the drives that are not being updated (for example via DASD bus 300 in FIG. 2). (The data read is from the data drives that are not being updated, and the P and Q drives need not be read.) Then firmware will invoke this invention only once to generate both the P and Q parity. (The calculations take place wholly within the RAID adaptor 200 in FIG. 2.) Per this invention hardware will read data only once from memory and then write to memory both the new P and Q parity (further details of this invention's flow are described below). Firmware then instructs hardware to write the new data to those data drives and to write the new P parity and Q parity to those parity drives. Importantly, with both the previously mentioned full strip write and the partial stripe write just mentioned, the invention minimizes traffic on the DRAM bus 210 as compared with some prior-art approaches. The number of memory accesses required to read the data from memory, and to write back to memory the P and Q for the stripe, is only N+2.

Single-drive write. For a single-drive write, firmware will first instruct the hardware to DMA all the new data to memory. Then firmware will instruct hardware to read the old data, that will be updated, from the drive to memory. Then firmware will instruct hardware to read the old P parity and Q parity from the drives to memory. Then firmware will invoke this invention once to generate both the P and Q parity. Per this invention hardware will read old data and new data data only once from memory and then write to memory both the new P and Q parity (further details of this invention's flow are described below). Firmware then instructs hardware to write the new data to the data drive and to write the new P parity and Q parity to those parity drives. Here, as before, the traffic on busses 110 and 300 is minimized as compared with some prior-art approaches.

Regenerating the missing data in a stripe. When one or two drives fail, to regenerate the missing data in a stripe, firmware 240 will first instruct the hardware to DMA all good data from the data and parity drives (via DASD bus 300) to memory. Then firmware will invoke this invention once to generate all the missing data/parity. Per this invention hardware will read data only once from memory and then write to memory both missing drives data for this stripe (further details of this inventions flow are described below). Firmware then uses this data either to provide it to the system for a read (via host bus 110) or to write out to a hot spare drive (via DASD bus 300), or to write out to a replacement drive (via DASD bus 300).

It is instructive to describe how the calculations within the adaptor 200 are performed.

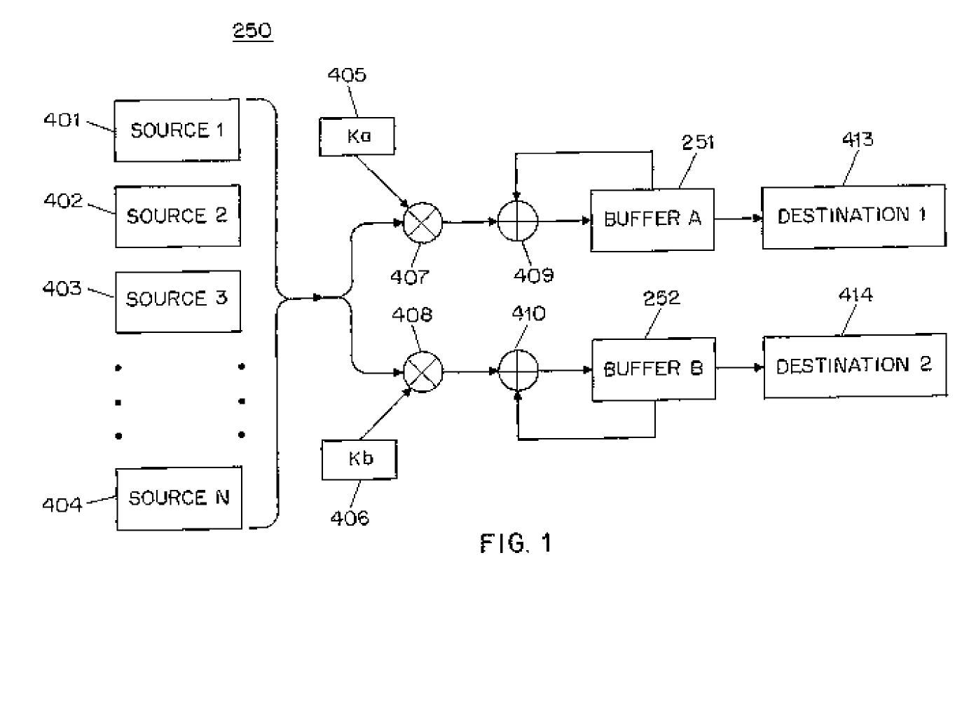

In this invention, each byte of source data is read from memory only once. Then, each byte of source data is multiplied by two different constants (e.g. Ka 405, Kb 406 in FIG. 1), one for computing the first set of result data (data flow 407, 409, 251) and one for the second (data flow 408, 410, 252). These two constants are simply the coefficients corresponding to the particular source data term in the two solution equations. After the source data have been multiplied by the two constants (e.g. with multipliers 407, 408), it is XORed (XOR 409, 410) with, on the first source with zero, and on all subsequent sources with the accumulated sum of products (feedback path from 251 to 409 and from 252 to 410). Once each source has been multiplied and added into the sum of products, the two small internal buffers 251, 252 are flushed out to memory. The engine works on slices of the data, for example if the internal buffers 251 and 252 are 512 bytes in size, then the invention will read the first 512 bytes from each of the N sources as described above, then write the first 512 bytes of result from 251 to Destination 1 413 and from 252 to Destination 2 414. This process is repeated on the second slice of the sources, and so on, until all the source data have been processed.

With this sum-of-products accelerator, each set of source data is read from memory only once, each result is written to memory only once, and there are no other accesses to memory. This reduces the requirements on memory speed and increases the subsystem throughput.

In this accelerator, each source is read from memory and sent to two multipliers. In FIG. 1, for example, a particular piece of source data (e.g. stored in source 1, reference designation 401) is passed at one time to computational path 407, 409, 251 and simultaneously (or perhaps at a different time) to computational path 408, 410, 252. The multipliers 407, 408 then compute the products of the source data and input constants where the input constants (Ka 405, Kb 406) are provided by firmware for each source data (Each source 401, 402 etc. has two unique constants Ka, Kb, for example if there are 16 sources then there are 32 constants). The products from the multipliers 407, 408 are then sent to the two XOR engines 409, 410 which XORs the product with the accumulated products from the previous sources. The result of the XOR engines goes into two separate internal buffers 251, 252 which, when all products have been XORed together, are written out to memory (e.g. to destinations 413, 414).

In an exemplary embodiment the first and second computational paths, including the multipliers 407, 408, the XORs 409, 410, and the buffers 251, 252 are all within a single integrated circuit, and the feedback paths from buffers 251, 252 back to the XORs 409, 410 are all within the single integrated circuit. In this way the number of memory reads (from the source memories 401-404 and to the destination memories 413, 4144) for a given set of calculations is only N+2.

It is instructive to compare the workings of the inventive accelerator with prior-art efforts to provide accelerators. With a prior-art attempt at an accelerator, as mentioned above, the old approach calls for 2N+2 operations that firmware must instruct the hardware to perform.

With one prior-art attempt at an accelerator, there is a single computational path analogous to the top half of FIG. 1, that is, with a single multiplier, single XOR, etc.

In contrast, with the inventive approach, each set of input data is read from the input buffers once, multiplied internally by two different constants, and the products are added to the respective results and are then written out to the result buffers. A particular read is passed to both of the multipliers 407, 408 so that calculations can be done in parallel, and so that the read need only be performed once. With this invention, for N input buffers and 2 destinations there are N+2 buffer accesses.

This reduces the number of memory accesses and only requires firmware to set up the hardware to perform one operation. In a subsystem with limited bandwidth to memory, this invention will greatly improve performance.

Hot Spares

In this discussion we frequently refer to a RAID-6 system where the number of data drives is (for example) N and thus with P and Q redundancy drives the total number of drives is N+2. It should be appreciated, however, that in many RAID-6 systems, the designer may choose to provide one or more “hot spare” drives. Hot spare drives are provided in a DASD array so that if one of the working drives fails, rebuilding of the contents of the failed drive may be accomplished onto one of the hot spare drives. In this way the system need not rely upon a human operator to pull out a failed drive right away and to insert a replacement drive right away. Instead the system can start using the hot spare drive right away, and at a later time (in less of a hurry) a human operator can pull the failed drive and replace it. As a matter of terminology, then, the total number of drives physically present in such a system could be more than N+2. But the discussion herein will typically refer to N data drives and a total number of drives (including P and Q) as N+2, without excluding the possibility that one or more hot spare drives are also present if desired.

### EXAMPLE

A stripe write example where N=2. The invention will be described in more detail with respect to an example in which N+2 (the total number of drives) equals 4. It should be appreciated that the invention is not limited to the particular case of N=2 and in fact offers its benefits in RAID-6 systems where N is a much larger number. In addition it should be appreciated that the invention can offer its benefits with RAID systems that are at RAID levels other than RAID 6.

Turning now to FIG. 2, the RAID Adaptor 200 would DMA data from the Host 100 over the host bus 110 into buffers 221 and 222 in external DRAM 220 on the RAID Adaptor 200. Buffer 221 is large enough to hold all the write data going to DASD 311 for this stripe write. Buffer 222 is large enough to hold all the write data going to DASD 312 for this stripe write. Buffer 223 will hold the P for this stripe; this data will go to DASD 313. Buffer 224 will hold the Q for this stripe write; this data will go to DASD 314. The Processor Firmware 240 instructs the invention, hardware Accelerator 250, to generate P and Q for the stripe.

Importantly, the Accelerator reads a part of Buffer 221 (typically 512 bytes) over the DRAM bus 210, and use the first two RS (Reed-Solomon) coefficients (Ka, Kb in FIG. 1) to generate a partial P and Q, storing these intermediate results in the partial internal buffers 251 and 252. The Accelerator then reads a part of Buffer 222 (again, typically 512 bytes) over the DRAM bus 210, and use the next two RS coefficients to generate a partial P and Q storing these in partial internal buffers 251 and 252. In this example where N=2, there are two data sources, so the last of the two data sources will by now have been read and the computation is complete. The internal buffer 251, which now contains the result of a computation, is written via DRAM bus 210 to external buffer 223. Likewise internal buffer 252 is written via DRAM bus 210 to external buffer 224. The steps described in this paragraph are repeated for each remaining 512-byte portion in the input buffers 221, 222 until all computations for the stripe have been performed.

Then firmware will instruct hardware to do the following:
write data from Buffer 221 over the DRAM bus 210 to the DASD bus 300 and to DASD 311.
write data from Buffer 222 over the DRAM bus 210 to the DASD bus 300 and to DASD 312.
write P from Buffer 223 over the DRAM bus 210 to the DASD bus 300 and to DASD 313.
write Q from Buffer 224 over the DRAM bus 210 to the DASD bus 300 and to DASD 314.

These operations are optimally started by firmware overlapped. (They could be carried out seriatim but it is optimal that they be overlapped.) The bus 300 is, generally, a DASD (directly addressed storage device) bus, and in one implementation the bus 300 could be a SAS (serial attached SCSI) bus.

In an exemplary embodiment, the invention is implemented in an ASIC 230, and the RAID firmware 240 runs on an embedded PPC440 (processor) in that same ASIC 230.

The same hardware just described is able to read data and/or P/Q from the buffer, to do the RS calculations, and to write the data and/or P/Q back to the buffer in the best way possible (using a single invocation from firmware).

It will be appreciated that the moving of data to/from the host and moving data/P/Q to/from the drives is done in a standard RAID-6 fashion and these movements are only described to show how the invention is used. The particular type of data bus between the adaptor 200 and the host 100 is not part of the invention and could be any of several types of host bus without departing from the invention. For example it could be a PCI bus or a PCIe bus, or fibre channel or Ethernet. The particular type of drives connected to the adaptor 200, and the particular type of DASD bus 300 employed, is not part of the invention and could be any of several types of DASD drive and bus without departing from the invention. For example the bus could be SAS, SATA (serial ATA) or SCSI. The type of drive could be SATA or SCSI for example.

It is again instructive to compare the system according to the invention with implementations that have been tried in past years, all without having achieved satisfactory performance.

As one example, the prior RS calculations would have been done in software, either on a Host processor (e.g. in host 100 in FIG. 2) or by firmware in an embedded processor. Those calculations would have been very processor- and memory-intensive, and such a solution would not provide bandwidth needed for a successful RAID-6 product.

A simple RS hardware engine would just read a buffer, do the RS math and write back to a buffer. In a stripe write with 16 data drives and two parity drives (eighteen total drives) that engine would have to be invoked 16 times, then the resulting 16 buffers would have to be XORed together to generate the P result. What's more, that engine would have to be invoked 16 more times and those 16 resulting buffers would then have to be XORed together to generate the Q result. This is still very memory intensive, plus firmware is still invoked many times to reinstruct the hardware.

Since the same source data is used in both the P and Q calculation, the system according to the invention calculates them simultaneously, that way the source data is read from the buffer only once. The system according to the invention keeps a table of all the RS coefficients, 32 in the case of a 16-drive system, so that firmware does not have to reinstruct the hardware. And the system according to the invention keeps all the partial products stored internally so that only the final result is written back to the buffer. This generates a minimum number of external buffer accesses, resulting in a maximum performance.

It will be appreciated that one apparatus that has been described is an apparatus which performs one or more sum-of-products calculations given multiple sources, each with one or more corresponding coefficients, and one or more destinations. With this apparatus, each source is only read once, each destination is only written once, and no other reads or writes are required. With this apparatus, when applied to the particular case of Reed-Solomon codes for RAID 6, the sum-of-products is computed using finite-field arithmetic. The apparatus is implemented as a hardware accelerator which will perform all of the calculations necessary to compute the result of two sum-of-products calculations as a single operation without software intervention. The RAID subsystem can have hardware capable of generating data for multiple sum-of-products results given a set of input data and multiple destinations. In one embodiment, the system is one in which the data for the data drives is read from the subsystem memory only once, the redundancy data (P and Q information) is written into subsystem memory only once, and no other memory accesses are part of the operation. Desirably, in this system, the sum-of-products is computed entirely by hardware and appears as a single operation to software.

In one application, the inputs to the sum-of-products calculation are the change in data for one drive and two or more sets of redundancy data from the redundancy drives and the results are the new sets of redundancy data for the redundancy drives.

In another application, the inputs to the sum-of-products calculations are the sets of data from all of the available drives and the results are the recreated or rebuilt sets of data for the failed or unavailable drives.

It should be noted that while in the examples in this invention disclosure refer to two sets of result data or destinations for the two sum of products results, the scope of the invention is meant to cover two destinations or more than two destinations. For instance, if rather than a RAID-6 implementation, a RAID implementation which supported three or more sets of redundancy data and three or more disk failures could also use this accelerator. In such a case, in addition to the two computational paths 407, 409, 251 and 408, 410, 252, there would be at least one additional computational path running in parallel with its own source of constants provided to a multiplier, its own path to an XOR, and its own buffer with feedback for finite-field polynomial calculations.

Discussion in greater detail. It is instructive to describe the various methods and apparatus according to the invention yet again, in rather more detail.

One method, for a full stripe write, is for use with an adaptor 200, and a host 100 running an operating system communicatively coupled by a first communications means 110 with the adaptor 200, and an array of N+2 direct access storage devices 311-314, N being at least one, the array communicatively coupled with the adaptor 200 by a second communications means 300, the adaptor 200 not running the same operating system as the host 100, the method comprising the steps of:
reading first through N^{th} source data from the host to respective first through N^{th} source memories (401-404 in FIG. 1; 221-224 in FIG. 2) in the adaptor 200 by the first communications means 110;
performing two sum-of-products calculations entirely within the adaptor 200, each calculation being a function of each of the first through N^{th} source data, each of the two calculations each further being a function of N respective predetermined coefficients (405-406 in FIG. 1), each of the two calculations yielding a respective first and second result (accumulated in buffers 251, 252), the calculations each performed without the use of the first communications means and each performed without the use of the second communications means;
the calculations requiring only N+2 memory accesses;
writing the first through Nth source data to first through N^{th} direct access storage devices by the second communications means, and
writing the results of the two calculations to N+1^{th} and N+2^{th} direct access storage devices by the second communications means.

Another method involving a single-drive write drawing upon existing P and Q information, involves reading first source data from the host to a first source memory in the adaptor by the first communications means; reading at least second and third source data from respective at least two direct access storage devices by the second communications means; performing two sum-of-products calculations entirely within the adaptor, each calculation being a function of the first source data and of the at least second and third source data, each of the two calculations each further being a function of at least three respective predetermined coefficients, each of the two calculations yielding a respective first and second result, the calculations each performed without the use of the first communications means and each performed without the use of the second communications means; the calculations requiring only N+2 memory accesses; writing the first source data to a respective first direct access storage device by the second communications means, and writing the results of the two calculations to second and third direct access storage devices (receiving P and Q redundancy information) by the second communications means.

Yet another method involving a single-drive write drawing upon all of the other data drives and not drawing up on existing P and Q information, comprises the steps of: reading first source data from the host to a first source memory in the adaptor by the first communications means; reading second through N^{th} source data from respective at least N−1 direct access storage devices by the second communications means; performing two sum-of-products calculations entirely within the adaptor, each calculation being a function of the first source data and of the second through N^{th} source data, each of the two calculations each further being a function of at least N respective predetermined coefficients, each of the two calculations yielding a respective first and second result, the calculations each performed without the use of the first communications means and each performed without the use of the second communications means; the calculations requiring only N+2 memory accesses; writing the first source data to a respective first direct access storage device by the second communications means, and writing the results of the two calculations to N+1^{th} and N+2^{th} direct access storage devices by the second communications means.

A method for a partial stripe write comprises the steps of: reading first through M^{th} source data from the host to respective first through M^{th} source memories in the adaptor by the first communications means; reading M+1^{th} through N^{th} source data from respective at least N-M direct access storage devices by the second communications means; performing two sum-of-products calculations entirely within the adaptor, each calculation being a function of the first source data and of the second through Nth source data, each of the two calculations each further being a function of at least N respective predetermined coefficients, each of the two calculations yielding a respective first and second result, the calculations each performed without the use of the first communications means and each performed without the use of the second communications means; the calculations requiring only N+2 memory accesses; writing the first through M^{th} source data to respective first through M^{th} direct access storage devices by the second communications means, and writing the results of the two calculations to N+1^{th} and N+2^{th} direct access storage devices by the second communications means.

A method for recovery of data upon loss of two drives comprises the steps of: reading third through N+2^{th} source data from respective at least N direct access storage devices by the second communications means; and performing two sum-of-products calculations entirely within the adaptor, each calculation being a function of the third through N+2^{th} source data, each of the two calculations each further being a function of at least N respective predetermined coefficients, each of the two calculations yielding a respective first and second result, the calculations each performed without the use of the first communications means and each performed without the use of the second communications means; the calculations requiring only N+2 memory accesses.

An exemplary adaptor apparatus comprises: a first interface disposed for communication with a host computer; a second interface disposed for communication with an array of direct access storage devices; N input buffers within the adaptor apparatus where N is at least one; a first sum-of-products engine within the adaptor and responsive to inputs from the N input buffers and responsive to constants and having a first output; a second sum-of-products engine within the adaptor and responsive to inputs from the N input buffers and responsive to constants and having a second output; each of the first and second sum-of-products engines performing finite-field multiplication and finite-field addition; storage means within the adaptor storing at least first, second, third and fourth constants; a control means within the adaptor; the control means disposed, in response to a first single command, to transfer new data from the host into the N input buffers, to perform a first sum-of-products calculation within the first sum-of-products engine using first constants from the storage means yielding the first output, to perform a second sum-of-products calculation within the second sum-of-products engine using second constants from the storage means yielding the second output, the first and second sum-of-products calculations performed without the use of the first interface, the first and second sum-of-products calculations performed without the use of the second interface, thereafter to transfer the new data via the second interface to direct access storage devices and to transfer the first and second outputs via the second interface to direct access storage devices; the control means disposed, in response to a second single command, to transfer data from N−2 of the direct access storage devices into the N input buffers, to perform a third sum-of-products calculation within the first sum-of-products engine using third constants from the storage means yielding the first output, to perform a fourth sum-of-products calculation within the second sum-of-products engine using fourth constants from the storage means yielding the second output, the third and fourth sum-of-products calculations performed without the use of the first interface, the third and fourth sum-of-products calculations performed without the use of the second interface, thereafter to transfer the first and second outputs via the second interface to direct access storage devices or to transfer the first and second outputs via the first interface to the host.

The apparatus may further comprise a third sum-of-products engine within the adaptor and responsive to inputs from the N input buffers and responsive to constants and having a third output; the third sum-of-products engine performing finite-field multiplication and finite-field addition.

In this apparatus, the calculations of the first and second sum-of-products engines together with the constants may comprise calculation of Reed-Solomon redundancy data. In this apparatus, the first sum-of-products engine and the second sum-of-products engine may operate in parallel. In this apparatus, the first sum-of-products engine and the second sum-of-products engine may lie within a single application-specific integrated circuit, in which case the first single command and the second single command may be received from outside the application-specific integrated circuit. In this apparatus, it is desirable that the first sum-of-products engine receives its input from a memory read, and that the second sum-of-products engine receives its input from the same memory read.

It will be appreciated that those skilled in the art will have no difficulty at all in devising myriad obvious improvements and variants of the embodiments disclosed here, all of which are intended to be embraced by the claims which follow.

What is claimed is:

1. A method for use with an adaptor, and a host running an operating system communicatively coupled by a first communications means with the adaptor, and an array of N+2 direct access storage devices, N being at least one, the array communicatively coupled with the adaptor by a second communications means, the adaptor not running the same operating system as the host, the method comprising the steps of:
reading first through N^{th} source data from the host to respective first through N^{th} source memories in the adaptor by the first communications means;
performing two sum-of-products calculations entirely within the adaptor, each calculation being a function of each of the first through N^{th} source data, each of the two calculations each further being a function of N respective predetermined coefficients, each of the two calculations yielding a respective first and second result, the calculations each performed without the use of the first communications means and each performed without the use of the second communications means;
the calculations requiring only N+2 memory accesses;
writing the first through N^{th} source data to first through N^{th} direct access storage devices by the second communications means, and
writing the results of the two calculations to N+1^{th} and N+2^{th} direct access storage devices by the second communications means.

2. The method of claim 1 wherein each of the sum-of-products calculations is performed using finite-field arithmetic.

3. A method for use with an adaptor, and a host running an operating system communicatively coupled by a first communications means with the adaptor, and an array of N+2 direct access storage devices, N being at least one, the array communicatively coupled with the adaptor by a second communications means, the adaptor not running the same operating system as the host, the method comprising the steps of:
reading first source data from the host to a first source memory in the adaptor by the first communications means;
reading at least second and third source data from respective at least two direct access storage devices by the second communications means;
performing two sum-of-products calculations entirely within the adaptor, each calculation being a function of the first source data and of the at least second and third source data, each of the two calculations each further being a function of at least three respective predetermined coefficients, each of the two calculations yielding a respective first and second result, the calculations each performed without the use of the first communications means and each performed without the use of the second communications means;
the calculations requiring only N+2 memory accesses;
writing the first source data to a respective first direct access storage device by the second communications means, and
writing the results of the two calculations to second and third direct access storage devices by the second communications means.

4. The method of claim 3 wherein each of the sum-of-products calculations is performed using finite-field arithmetic.

5. A method for use with an adaptor, and a host running an operating system communicatively coupled by a first communications means with the adaptor, and an array of N+2 direct access storage devices, N being at least one, the array communicatively coupled with the adaptor by a second communications means, the adaptor not running the same operating system as the host, the method comprising the steps of:
reading first source data from the host to a first source memory in the adaptor by the first communications means;
reading second through N^{th} source data from respective at least N−1 direct access storage devices by the second communications means;
performing two sum-of-products calculations entirely within the adaptor, each calculation being a function of the first source data and of the second through N^{th} source data, each of the two calculations each further being a function of at least N respective predetermined coefficients, each of the two calculations yielding a respective first and second result, the calculations each performed without the use of the first communications means and each performed without the use of the second communications means;
the calculations requiring only N+2 memory accesses;
writing the first source data to a respective first direct access storage device by the second communications means, and
writing the results of the two calculations to N+1^{th} and N+2^{th} direct access storage devices by the second communications means.

6. The method of claim 4 wherein each of the sum-of-products calculations is performed using finite-field arithmetic.

7. A method for use with an adaptor, and a host running an operating system communicatively coupled by a first communications means with the adaptor, and an array of N+2 direct access storage devices, N being at least one, the array communicatively coupled with the adaptor by a second communications means, the adaptor not running the same operating system as the host, the method comprising the steps of:
reading first through M^{th} source data from the host to respective first through M^{th} source memories in the adaptor by the first communications means;
reading M+1^{th} through N^{th} source data from respective at least N-M direct access storage devices by the second communications means;
performing two sum-of-products calculations entirely within the adaptor, each calculation being a function of the first source data and of the second through N^{th} source data, each of the two calculations each further being a function of at least N respective predetermined coefficients, each of the two calculations yielding a respective first and second result, the calculations each performed without the use of the first communications means and each performed without the use of the second communications means;
the calculations requiring only N+2 memory accesses;
writing the first through M^{th} source data to respective first through M^{th} direct access storage devices by the second communications means, and
writing the results of the two calculations to N+1^{th} and N+2^{th} direct access storage devices by the second communications means.

8. The method of claim 7 wherein each of the sum-of-products calculations is performed using finite-field arithmetic.

9. A method for use with an adaptor, and a host running an operating system communicatively coupled by a first communications means with the adaptor, and an array of N+2 direct access storage devices, N being at least one, the array communicatively coupled with the adaptor by a second communications means, the adaptor not running the same operating system as the host, the method comprising the steps of:
reading third through N+2^{th} source data from respective at least N direct access storage devices by the second communications means; and
performing two sum-of-products calculations entirely within the adaptor, each calculation being a function of the third through N^{th} source data, each of the two calculations each further being a function of at least N respective predetermined coefficients, each of the two calculations yielding a respective first and second result, the calculations each performed without the use of the first communications means and each performed without the use of the second communications means;
the calculations requiring only N+2 memory accesses.

10. The method of claim 9 further comprising the step of:
writing the results of the two calculations to replacements of the first and second direct access storage devices by the second communications means.

11. The method of claim 9 further comprising the step of:
writing the results of the two calculations to respective hot spare direct access storage devices by the second communications means.

12. The method of claim 9 further comprising the step of:
writing the results of the two calculations to the host by the first communications means.

13. The method of claim 10 wherein each of the sum-of-products calculations is performed using finite-field arithmetic.

14. The method of claim 11 wherein each of the sum-of-products calculations is performed using finite-field arithmetic.

15. The method of claim 12 wherein each of the sum-of-products calculations is performed using finite-field arithmetic.

16. Adaptor apparatus for use with a host computer and an array of direct access storage devices, the adaptor apparatus comprising:
a first interface disposed for communication with a host computer;
a second interface disposed for communication with an array of direct access storage devices;
N input buffers within the adaptor apparatus where N is at least one;
a first sum-of-products engine within the adaptor and responsive to inputs from the N input buffers and responsive to constants and having a first output;
a second sum-of-products engine within the adaptor and responsive to inputs from the N input buffers and responsive to constants and having a second output;
each of the first and second sum-of-products engines performing finite-field multiplication and finite-field addition;
storage means within the adaptor storing at least first, second, third and fourth constants;
a control means within the adaptor;
the control means disposed, in response to a first single command, to transfer new data from the host into the N input buffers, to perform a first sum-of-products calculation within the first sum-of-products engine using first constants from the storage means yielding the first output, to perform a second sum-of-products calculation within the second sum-of-products engine using second constants from the storage means yielding the second output, the first and second sum-of-products calculations performed without the use of the first interface, the first and second sum-of-products calculations performed without the use of the second interface, thereafter to transfer the new data via the second interface to direct access storage devices and to transfer the first and second outputs via the second interface to direct access storage devices;
the control means disposed, in response to a second single command, to transfer data from N of the direct access storage devices into the N input buffers, to perform a third sum-of-products calculation within the first sum-of-products engine using third constants from the storage means yielding the first output, to perform a fourth sum-of-products calculation within the second sum-of-products engine using fourth constants from the storage means yielding the second output, the third and fourth sum-of-products calculations performed without the use of the first interface, the third and fourth sum-of-products calculations performed without the use of the second interface, thereafter to transfer the first and second outputs via the second interface to direct access storage devices or to transfer the first and second outputs via the first interface to the host.

17. The apparatus of claim 16 wherein N is at least six.

18. The apparatus of claim 17 wherein N is at least sixteen.

19. The apparatus of claim 16 further comprising:
a third sum-of-products engine within the adaptor and responsive to inputs from the N input buffers and responsive to constants and having a third output;
the third sum-of-products engine performing finite-field multiplication and finite-field addition.

20. The apparatus of claim 16 wherein calculations of the first and second sum-of-products engines together with the constants comprises calculation of Reed-Solomon redundancy data.

21. The apparatus of claim 16 wherein the first sum-of-products engine and the second sum-of-products engine operate in parallel.

22. The apparatus of claim 16 wherein the first sum-of-products engine and the second sum-of-products engine are within a single application-specific integrated circuit.

23. The apparatus of claim 22 wherein the first single command and the second single command are received from outside the application-specific integrated circuit.

24. The apparatus of claim 16 wherein the first sum-of-products engine receives its input from a memory read, and wherein the second sum-of-products engine receives its input from the same memory read.

25. A method for use with a storage adapter, the method comprising the steps of:
reading N inputs from memory, N being at least one, and for each of the N inputs read from memory:
performing a part of a first redundancy calculation with respect to the each of the N inputs read from memory, the part of the first redundancy calculation comprising performing a finite-field multiply with respect to a respective constant, and XORing the finite-field product with any previous part of the first redundancy calculation;
performing a part of a second redundancy calculation with respect to the each of the N inputs read from memory, the part of the second redundancy calculation comprising performing a finite-field multiply with respect to a respective constant, and XORing the finite-field product with any previous part of the second redundancy calculation;
repeating the reading step, the performing-a-part-of-a-first-redundancy-calculation step, and the performing-a-part-of-a-second-redundancy-calculation step, until all of the N reads have been done and the first and second redundancy calculations have been completed; and
writing a result of the first redundancy calculation to memory;
writing a result of the second redundancy calculation to memory;
whereby the total number of memory reads and writes is only N+2.

26. A method for use with a storage adapter, the method comprising the steps of:
reading N inputs from memory, N being at least one, and for each of the N inputs read from memory:
performing a part of a first redundancy calculation with respect to the each of the N inputs read from memory, the part of the first redundancy calculation comprising performing a finite-field multiply with respect to a respective constant, and XORing the finite-field product with any previous part of the first redundancy calculation;
performing a part of a second redundancy calculation with respect to the each of the N inputs read from memory, the part of the second redundancy calculation comprising performing a finite-field multiply with respect to a respective constant, and XORing the finite-field product with any previous part of the second redundancy calculation;
repeating the reading step, the performing-a-part-of-a-first-redundancy-calculation step, and the performing-a-part-of-a-second-redundancy-calculation step, until all of the N reads have been done and the first and second redundancy calculations have been completed; and
writing a result of the first redundancy calculation to memory;
writing a result of the second redundancy calculation to memory;
the first and second redundancy calculations performed in parallel.

27. A method for use with a storage adapter, the method comprising the steps of:
reading N inputs from memory, N being at least one, and for each of the N inputs read from memory:
performing a part of a first redundancy calculation with respect to the each of the N inputs read from memory, the part of the first redundancy calculation comprising performing a finite-field multiply with respect to a respective constant, and XORing the finite-field product with any previous part of the first redundancy calculation;
performing a part of a second redundancy calculation with respect to the each of the N inputs read from memory, the part of the second redundancy calculation comprising performing a finite-field multiply with respect to a respective constant, and XORing the finite-field product with any previous part of the second redundancy calculation;
repeating the reading step, the performing-a-part-of-a-first-redundancy-calculation step, and the performing-a-part-of-a-second-redundancy-calculation step, until all of the N reads have been done and the first and second redundancy calculations have been completed; and
writing a result of the first redundancy calculation to memory;
writing a result of the second redundancy calculation to memory;
wherein the finite-field multiplications of the first redundancy calculation, the XORing of the first redundancy calculation, and storage of partial results of the first redundancy calculation, and the the finite-field multiplications of the first redundancy calculation, the XORing of the first redundancy calculation, and storage of partial results of the first redundancy calculation, are all performed within a single application-specific integrated circuit.
